(19) United States
(12) Patent Application Publication
(10) Pub. No.: US 2010/0132329 A1
(43) Pub. Date: Jun. 3, 2010

(54) Method of Reusing Promotional or Decorative Items

(76) Inventor: Bonnie Rose, Sedona, AZ (US)

Correspondence Address: AKERMAN SENTERFITT, P.O. BOX 3188, WEST PALM BEACH, FL, 33402-3188, US

(21) Appl. No.: 12/325,872

(22) Filed: Dec. 1, 2008

(51) Int. Cl. F16G 13/00

(52) U.S. Cl. 59/80

(57) ABSTRACT

A method of reusing promotional and/or decorative items includes obtaining a plurality of credit card-style cards, such as gift cards, cutting each card into a card piece of a desired shape, the card piece being selected or cut to form a decorative object, and linking a plurality of the decorative card pieces together with links to form a flexible chain, whereby the flexible chain can form a new promotional or decorative item. The flexible chain can be used as a belt, for example.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Field of the Invention

The present invention relates to a method of reusing promotional or decorative items to form new decorative and/or promotional items, and more particularly, to a decorative belt, necklace or the like that can be-formed from leftover gift cards, credit cards or other promotional or decorative items.

2. Description of the Related Art

Many different types of decorative and/or promotional items exist. Promotional items are generally items that are given away by companies to consumers, and which bear the company's name or logo. The consumer can freely use the item and in return, provide some level of advertising for the company as they display the company's logo while using the item. Promotional items include pens, lanyards, t-shirts, tote bags, baseball and other hats, toys, water bottles, calculators, key rings, etc.

Credit card-like gift cards are an increasing part of retail business, as many consumers prefer to purchase a gift card to give to a recipient rather than an item that may not be to the recipient's taste. In 2005, it is estimated that approximately 13.6 billion gift cards were produced. As this sector of the market is increasing rapidly every year, it can be expected that this number will continue to grow. Typically a company will print various designs on gift cards, which may be varied for each holiday season. Alternatively, a company may produce a distinctive card, for example, adding holographic, diffractive, and reflective effects to traditional card graphics in order to produce a more pleasing visual effect. As companies do not know how many of these gift cards will be purchased in a given year or holiday season, they must always manufacture more cards than they anticipate selling, and so are often left with a large number of leftover gift cards that are typically destroyed when the particular design printed on the card is no longer being used.

Credit card-style cards are also increasingly used in other areas, and therefore a very large number of these types of cards are manufactured and disposed of each year. For example, hotel key cards, library cards, store customer loyalty cards, membership schemes, identification cards and many other items are formed from similar sized cards. Such cards may have decorative logos printed on them, or may otherwise be provided in interesting colors and color combinations. Thus, credit card-style cards can also form decorative items, even if they were not originally intended as such.

It is desirable to provide a way of reusing leftover gift cards, and other promotional and/or decorative cards, as well as credit cards and similar items so that they can have an extended life as a promotional item, and so that their environmental impact can be lessened.

### SUMMARY OF THE INVENTION

According to an arrangement of the present invention a method of reusing promotional or decorative items includes obtaining a plurality of credit card-style cards, such as gift cards, cutting each card into a card piece of a desired shape, the card piece being selected or cut to form a decorative object, and linking a plurality of the decorative card pieces together with links to form a flexible chain, whereby the flexible chain can form a new promotional or decorative item. The flexible chain can be used as a belt, for example.

A fastener can be attached to ends of the flexible chain such that the chain may be used as a belt, bracelet or necklace.

The step of cutting each card into card pieces can include selecting the desired shape in which to cut each card depending on the decoration already applied to the card.

In some arrangements, the plurality of decorative card pieces that are used to form the flexible chain can be of different sizes and/or shapes to give a pleasing look to the chain.

The invention also relates to a promotional or decorative item including a plurality of promotional or decorative credit card style cards that have been cut into a plurality of decorative card pieces, and a plurality of links joining the plurality of decorative card pieces, such that a flexible chain is formed.

A fastener can be attached to ends of the flexible chain such that the chain is usable as a belt, bracelet or necklace. The desired shape for each card piece can be selected depending on the decoration already applied to the card.

In some arrangements, the plurality of decorative card pieces that are used to form the flexible chain are of different sizes and/or shapes to give a pleasing look to the chain.

### BRIEF DESCRIPTION OF THE DRAWINGS

There are shown in the drawings arrangements which are presently discussed, it being understood, however, that the invention is not limited to the precise arrangements and instrumentalities shown, wherein:

FIG. 1 is a perspective view of a belt according to an arrangement of the invention.

FIG. 2 is a perspective view of a belt according to an arrangement of the invention.

### DETAILED DESCRIPTION OF THE DRAWINGS

The present invention is directed to a wearable decorative or promotional item such as a decorative belt, necklace, bracelet or the like that can be formed from leftover gift cards, credit or debit cards or other similar promotional or decorative items. The invention relates to the use of credit card style cards.

A credit card style card is any, generally plastic, card that is typically a standard credit card size (the ID-1 credit card format specifies a size of 85.60×53.98 mm (3.370×2.125 in) with a thickness of 0.76 mm and corners rounded with a radius of 3.18 mm). A business card size format is generally 67 mm×49 mm. The ID-2 format specifics a size of 105×74 mm (4.134×2.913 in). ID-000 specifies a size of 25 mm×15 mm. Other sizes of cards may be used. These cards may include a magnetic strip containing information, an embedded chip such as an EMV chip as typically supplied on a smart card, a magnetic loop antenna or may include visual identifying indicia only such as a bar code or a serial number. Identifying numbers may or may not be embossed on the card. Alternatively, no identifying indicia may be used, as the card may be a blank or generic card. Credit card style cards used in the present invention include, but are not limited to gift cards, credit cards, debit cards, ATM cards, identity cards, driving license cards, hotel key and other door entry cards, business cards, advertising cards, student/college identification cards, membership cards, discount cards and the like.

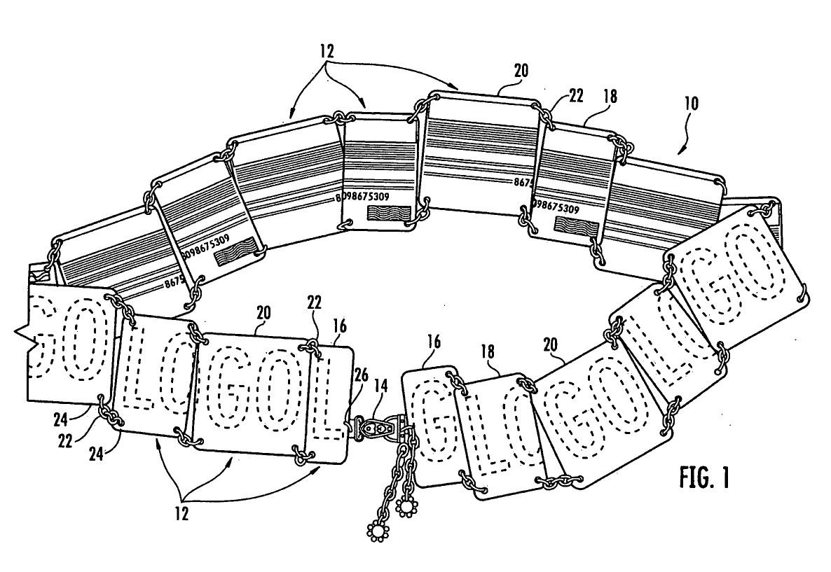

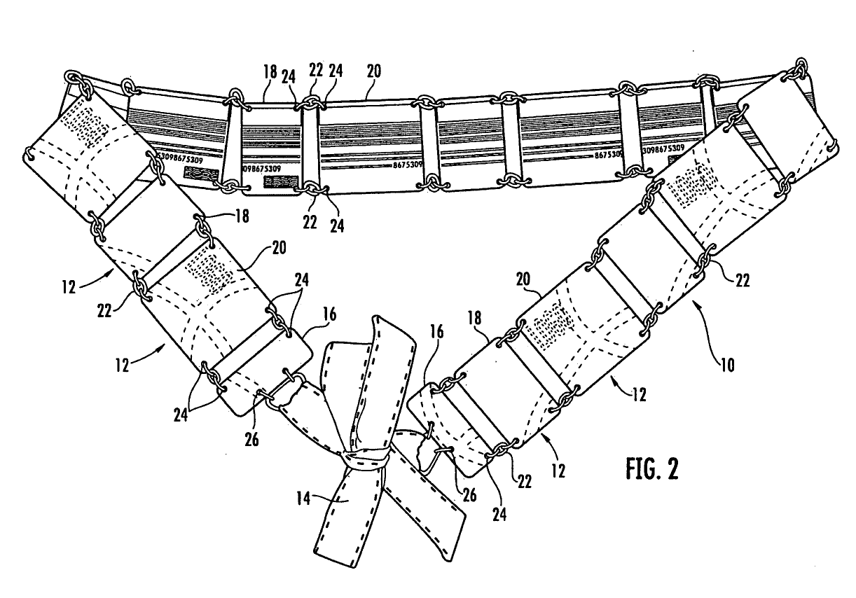

An arrangement of the present invention is shown in FIGS. 1-2, which illustrate variations of a decorative belt 10. The belt 10 may be formed of gift cards or any other promotional item. Preferably, the promotional item that is used is a generally flat, credit card style card, and is decorated either with a company logo and/or other decorative or colored features. Most preferably, the promotional item used is a gift card or other card that is typically the same size and shape as a credit card, and which may include a magnetic strip, barcode, circuitry or any other payment authorization means, which can be deactivated prior to the promotional items being turned into the belt 10 or other decorative item.

The gift cards, credit card-style cards or other promotional items can be cut into a plurality of belt pieces 12. The size and shape of the belt pieces may be varied, depending on the promotional item that is used to form the belt, and also on the size of the belt that is to be created. In one arrangement, as illustrated in the attached figures, the belt pieces 12 are provided in different sizes on one belt. In the illustrated arrangement, which is one example of the way a belt can be formed, the belt pieces can comprise two small belt pieces 16, one on either side of the buckle or fastener 14, a plurality of medium belt pieces 18 and a plurality of large belt pieces 20. The medium and large belt pieces can be arranged alternately around the belt although of course any arrangement of belt pieces may be used. In the illustrated arrangement, the height of all the belt pieces is the same, and is approximately 54 mm, which is the height of a standard credit card-sized card. The width of the small belt pieces 16 is approximately 19 mm. The width of the medium belt pieces 18 is approximately 34 mm. The width of the large belt pieces 20 is approximately 51 mm. In a particularly preferred arrangement, the large belt pieces 20 and the medium belt pieces 18 are cut from the same credit card-sized gift card, with the cut sides and corners having been appropriately smoothed or rounded so that the cut edges match the original sides of the gift or credit card. In this way, when a large and a medium belt piece are placed side-by-side, the original design of the gift card is visible.

It will be appreciated that any suitable size and shape belt pieces may be used. For example, if the original gift card or credit card included a word or words, it may be desirable to cut the gift card at an appropriate point for the word or words to still be easily visible when the belt is worn. Thus, a card reading “Old Navy”® may be cut between the words “Old” and “Navy” to form belt pieces that are different widths, whereas a card having words that are the same length, such as “The Gap”® may be cut to form belt pieces that are the same width. A similar concept may be used with the small belt pieces 16, that may be used at the ends of the belt. For example, the small belt pieces 16 may be cut to highlight a particular portion of the design, or a particular letter such as the capital “O” and the capital “N” from a card reading “Old Navy”®. In another example, if a photograph or other image is printed on the card, the size of the belt pieces 12 may be cut so that the majority of the image is visible on the belt piece, or so that a desired portion of the image is visible. The sizes and shapes of the belt pieces may be varied in one belt for a pleasing look, or may all be the same in one belt. A single belt may use cards from a number of different sources or the same source using different cards, to provide a more random look to the belt, or may use cards that are all in a similar color palette, or may use cards having similar design elements.

The belt pieces are joined together in a chain by links 22, which may include chain links or may involve other types of links. In the illustrated arrangement, three metallic chain links are used to form one link 22, but any number or types of links may be used. The use of three chain links allows the link 22 to be flexible and to allow the belt pieces 12 to move in different directions relative to one another. In the illustrated arrangement, the three chain links can separate the belt pieces by approximately 8-9 mm. The links 22 extend through holes 24 drilled into the belt pieces 12, and two links 22 may extend between each adjacent belt piece 12, one at the top and one at the bottom of each belt piece. In the illustrated arrangement, four holes 24 are drilled in each belt piece, one in each corner of the belt piece 12. Such an arrangement provides stability to the belt pieces 12 in use, and prevents the belt pieces from flipping over to show the backside of the belt pieces when worn on the body. The arrangement of holes can nevertheless be varied, as for example, the holes 24 can be provided in the center of the sides of each belt piece such that the belt pieces 12 have a single link 22 between each adjacent belt piece 12. The belt pieces 12 can similarly be used in a diamond or triangular orientation, and thus a single link 22 may extend from a corner of one belt piece to a corner of an adjacent belt piece, at the center of the belt. In yet a further arrangement, the belt pieces 12 may be arranged in a staggered or varied configuration, with some belt pieces 12 being of smaller height than other belt pieces or being turned in different orientations.

By providing two small belt pieces 16 at the ends of the belt, together with eight each of the medium and large belt pieces 18, 20, a belt can be made having a length of approximately 92 cm or 36″. The medium and large belt pieces 18, 20 are preferably arranged in an alternating arrangement. Where the medium and large belt pieces 18, 20 have been cut from the same gift card, this arrangement allows the original design of the gift card, or the words on the gift card to be repeated without interruption. Of course, a differing number of belt pieces can be used to make differently sized belts. The belt can be worn slung around the hips, or at the waist.

The buckle, clasp or other fastener 14 enables a wearer to secure the belt about their waist or hips. FIG. 1 shows one arrangement of a fastener, comprising a magnetic metallic clasp. FIG. 2 shows another arrangement of a fastener 14, comprising ribbon attached to two D-rings such that the belt may be tied with a bow. It will be appreciated that many different types of buckle, clasp or fastener may be used. The fastener 14 can be attached to the two small belt pieces 16 via holes 26 drilled into the center of the sides of the belt pieces 16. If the small belt pieces 16 are not provided as the ends of the belt 10, then the fastener 14 is attached to whichever belt pieces 12 form the free ends of the belt.

Although the illustrated arrangements are in the form of belts, the invention is not limited in this regard, as it can be applied to similar items, such as necklaces, bracelets, bag straps and the like. Alternatively, a chain of cards may be placed onto a bag or other item as a decorative detail.

It should be understood that the examples and arrangements described herein are for illustrative purposes only and that various modifications or changes in light thereof will be obvious to persons skilled in the art, and that such modifications or changes are to be included within the spirit and purview of this application. Moreover, the invention can take other specific forms without departing from the spirit or essential attributes thereof.

What is claimed is:

1. A method of reusing promotional or decorative items comprising the steps of:
obtaining a plurality of credit card-style cards;
cutting each card into a card piece of a desired shape, the card piece being selected or cut to form a decorative object; and
linking a plurality of the decorative card pieces together with links to form a flexible chain, whereby the flexible chain can form a new promotional or decorative item.

2. The method according to claim 1, wherein a fastener is attached to ends of the flexible chain such that the chain may be used as a belt, bracelet or necklace.

3. The method according to claim 1, wherein the step of cutting each card into card pieces includes selecting the desired shape in which to cut each card depending on the decoration already applied to the card.

4. The method according to claim 1, wherein the plurality of decorative card pieces that are used to form the flexible chain are of different sizes and/or shapes to give a pleasing look to the chain.

5. A promotional or decorative item comprising:
a plurality of promotional or decorative credit card-style cards that have been cut into a plurality of decorative card pieces; and
a plurality of links joining the plurality of decorative card pieces such that a flexible chain is formed.

6. The promotional or decorative item according to claim 5, wherein a fastener is attached to ends of the flexible chain such that the chain is usable as a belt, bracelet or necklace.

7. The promotional or decorative item according to claim 5, wherein the desired shape for each card piece is selected depending on the decoration already applied to the card.

8. The promotional or decorative item according to claim 5, wherein the plurality of decorative card pieces that are used to form the flexible chain are of different sizes and/or shapes to give a pleasing look to the chain.
